(19) United States
(12) Patent Application Publication
(10) Pub. No.: US 2010/0325661 A1
(43) Pub. Date: Dec. 23, 2010

(54) VIDEO/AUDIO BROADCASTING SYSTEM AND CUSTOMIZED BROADCASTING METHOD OF SAME

(75) Inventor: Tung-Chou LEE, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: ALPHA NETWORKS INC., Hsinchu (TW)

(21) Appl. No.: 12/821,710

(22) Filed: Jun. 23, 2010

(30) Foreign Application Priority Data
Jun. 23, 2009 (TW) 098121022

(51) Int. Cl. H04N 5/445

(52) U.S. Cl. 725/37

(57) ABSTRACT

A video/audio broadcasting system and customized video/audio broadcasting method selects a corresponding graphic user interface among multiple graphic user interfaces according to an operation of a user on the video/audio broadcasting system, and uses the corresponding graphic user interface to operate the video/audio broadcasting system, for receiving and broadcasting corresponding contents of a video/audio signal.

### FIELD OF THE INVENTION

The present invention relates to a video/audio broadcasting system and a video/audio broadcasting method of the same and, particularly to a video/audio broadcasting system and a video/audio broadcasting method which can provide customized graphic user interfaces.

### BACKGROUND OF THE INVENTION

With the progress of digital science and technology, current digital television (TV) sets or high picture quality TV sets have been increasingly developed and becoming more popular. Compared with traditional wireless or cable TV signals transmitted and received by analog format, current TV signals with digital format can be loaded with more high volume information by compression and coding, besides have the advantages of low noise and high definition, and therefore can increase more diversified video/audio contents for users.

Regarding to a current digital TV set or high picture quality TV set, generally is equipped with a receiving unit for receiving wireless video/audio signals with digital format, and therefore can directly broadcast digital wireless video/audio programs thereon. Or, the TV set can be linked to a digital video/audio signal source through an internet broadband connection, to receive and broadcast digital cable video/audio programs.

When a traditional analog TV set is expected to broadcast digital video/audio programs, a set top box is necessarily installed based on the current technology to receive a digital video/audio signal from the digital video/audio signal source 14 as illustrated in FIG. 1A. After the analog TV set 10 is connected to the set top box 11, an internet link function of the set top box 11 is used to link an internet 13 for receiving the digital video/audio signal transmitted from the digital video/audio signal source 14 and then broadcasting the digital video/audio signal on the TV set 10.

FIG. 1B shows a schematic view of receiving and broadcasting of an internet protocol television (IPTV) in digital TV technologies. In the figure, the user terminal is equipped with an analog TV set 20 and a set top box 21. The TV set 20 is connected to the set top box 21 and then externally connected to an internet 23 and a digital video/audio signal source 24 by a modem 22, to receive the digital video/audio signal transmitted from the digital video/audio signal source 24 and broadcast the digital video/audio signal on the TV set 20.

Since the digital video/audio transmission signal has the characteristic of carrying high volume information, compared with the technology era of analog cable TV, the service provider can provide more video/audio channels and video/audio programs. For example the application of IPTV, besides the broadcasting of real-time video/audio channels matched with general user watching habits, it is feasible to choose wanted or interested video/audio programs or video/audio items at any time for watching. Such operations for providing function and watching of diversified multi-media video/audio information can be performed by means of a user operating apparatus for example a remote controller came with the set top box.

In the situation of information diversification, since channels or programs available for receiving and watching are excessive and menus are complex, which easily causes troubles of searching and watching to the users.

In addition, although after the TV set displaying a function menu or interface according to a loaded setting in the set top box, the user can utilize relevant function keys such as arrow keys, number keys, a mode switch key and a confirm key on an accompanying remote controller to search wanted channels and to select and activate corresponding programs, however the displayed function menu or interface corresponding to the initial setting is a fixed model, and some channels or options in the function menu would not be used according to the user's personal watching habit. The user must repeatedly search and select commonly used video/audio channels from complex classification options or category folders in each operation. As a result, it would increases the inconvenience and thereby influences desire of watching digital video/audio programs.

### SUMMARY OF THE INVENTION

Accordingly, an objective of the present invention is to provide a video/audio broadcasting system and a video/audio broadcasting method, which can provide clear and concise function menus or interfaces for use.

Another objective of the present invention is to provide a video/audio broadcasting system and a video/audio broadcasting method, which can provide customized function menus or interfaces for use.

One aspect of the present invention is a video/audio broadcasting method, selecting a corresponding graphic user interface among multiple graphic user interfaces according to an operation of a user on a video/audio broadcasting system, and using the corresponding graphic user interface to operate the video/audio broadcasting system, for receiving and broadcasting a corresponding content of a video/audio signal.

Another aspect of the present invention is a video/audio broadcasting system including: at least a user operation apparatus, for selecting a corresponding graphic user interface among multiple graphic user interfaces according to an operation of a user; and a multi-media processing apparatus signal-connected to a video/audio signal source and the user operation apparatus, for receiving and broadcasting corresponding contents of a video/audio signal according to an operation performed on the corresponding graphic user interface.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic view of a digital video/audio broadcasting system,

FIG. 1B is a schematic view of another digital video/audio broadcasting system,

FIG. 2 is a schematic view of a video/audio broadcasting system in accordance with a first embodiment of the present invention,

FIG. 3 is a flowchart of a video/audio broadcasting method in accordance with the first embodiment of the present invention,

FIG. 4 is a schematic view of a video/audio broadcasting system in accordance with a second embodiment of the present invention,

FIG. 5 is a flowchart of a video/audio broadcasting method in accordance with the second embodiment of the present invention,

FIG. 6A is a schematic view of a video/audio broadcasting system in accordance with a third embodiment of the present invention,

FIG. 6B is a schematic view of an identity switching interface in the video/audio broadcasting system as illustrated in FIG. 6A, and

FIG. 7 is a flowchart of a video/audio broadcasting method in accordance with the third embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

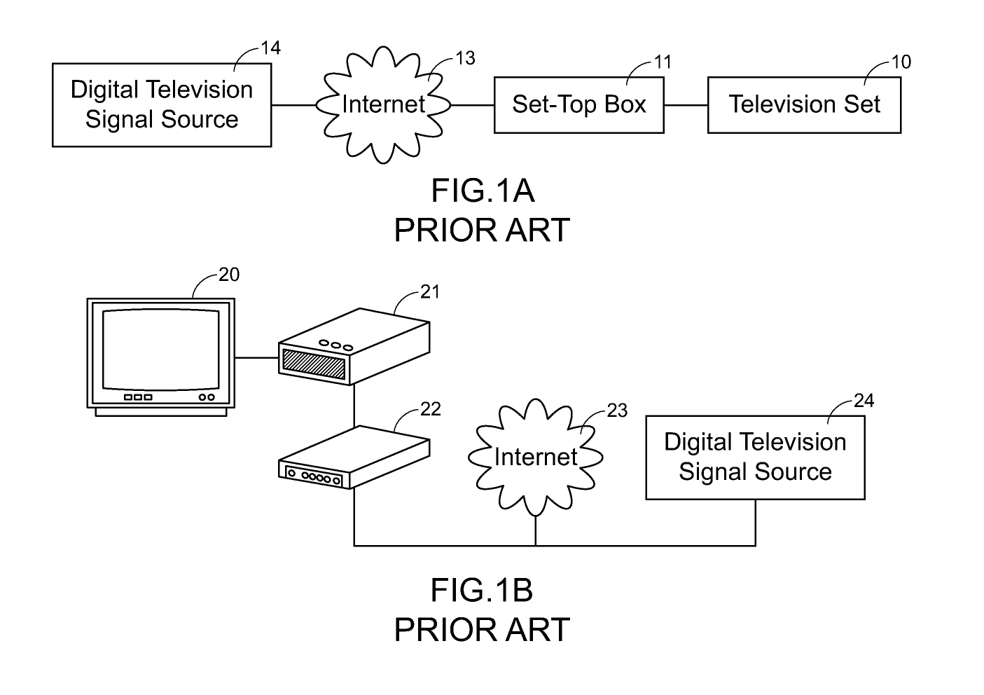

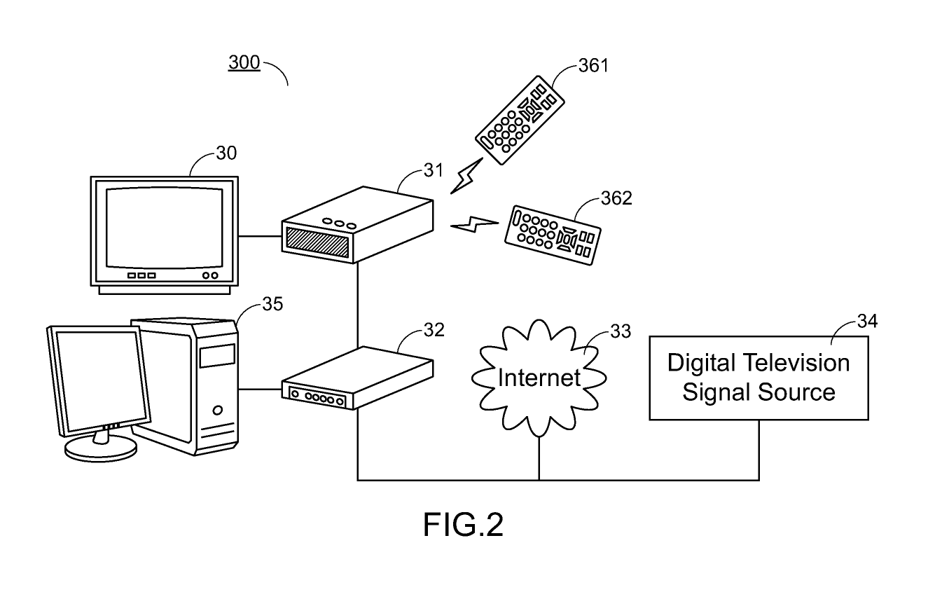

Referring to FIG. 2, a schematic view of a video/audio broadcasting system 300 in accordance with a first embodiment of the present invention is shown. In the present embodiment, the video/audio broadcasting system 300 is an internet protocol television (IPTV) system, and a major architecture thereof is similar to that as illustrated in FIG. 1B. The video/audio broadcasting system 300 additionally includes a multi-media processing apparatus which can be loaded or stored with multiple graphic user interfaces as function menus for users to operate, and then uses a display apparatus 30 in the system to watch digital video/audio programs. In the present embodiment, the multi-media processing apparatus is a set top box 31.

The above-mentioned multiple graphic user interfaces can allow the users to self-organize or self-define options, for different users to operate. The graphic user interfaces can be stored in the multi-media processing apparatus, can also be stored at a video/audio service provider which provides video/audio program sources, or stored in remote internet servers, internet hard discs and so forth, and further can be edited by a video/audio signal providing apparatus (such as a personal computer). The video/audio signal providing apparatus may provide an editor application software used for setting the graphic user interfaces, and then the users may load edited graphic user interfaces through Internet during the operation of the multi-media processing apparatus. A related setting technology can refer to the technical description as taught in U.S. utility patent application Ser. No. 12/728,452, the disclosure of which is fully incorporated herein by reference.

For example, referring to FIG. 2, a personal computer 35 is signal-connected to a modem 32 while the modem 32 is connected to a set top box 31. The user may use the related editing software loaded in the personal computer 35 for editing, or link to a webpage of a digital video/audio signal source 34 which provides a digital video/audio signal for amending, and therefore may re-edit the original function menus or interfaces in the set top box 31 according to users' personal habits or preferences and thereafter send them back to the set top box 31. Of course, the personal computer 35 may also be a remote computer linked to an internet 33.

Accordingly, by using such technology, the function menus or interfaces provided by the digital TV set or the set top box at the user end are no longer the original and universal model, but desired selection items can be appropriately edited, or less commonly used selection items can be listed behind the desired selection items or cancelled, so that the function menus or interfaces become more conformable to the demands of watching digital TV for the users. Accordingly, according to the inventive concept of the present invention, multiple graphic user interfaces stored in the multi-media processing apparatus (e.g., a digital TV set or the set top box 31) in the present embodiment can be set by a relevant electronic apparatus in the system for example the personal computer 35 loaded with editing software, and then stored in the set top box 31. Alternatively, the video/audio broadcasting system and the video/audio broadcasting method thereof proposed by the present invention, besides increasing relevant memory units or buffer memory space in the hardware aspect, may use a programming design in the software or firmware aspect to directly complete the selection and editing functions for the multiple graphic user interfaces in the set top box 31, and then use user operating apparatus such as remote controller(s) to send instructions for performing selection and editing operations on corresponding graphic user interfaces.

Continuing the above-mentioned descriptions, in the first embodiment, the set top box 31 is stored with multiple graphic user interfaces. For convenient descriptions, in the following, the set top box 31 stored with two graphic user interfaces i.e., a first graphic user interface and a second graphic user interface (not shown in figure), is taken as an example, and the system is designed to include two corresponding user operating apparatus, i.e., a first user operating apparatus 361 and a second user operating apparatus 362. Signal connections of the two user operating apparatus 361, 362 with the set top box 31 allows instructions to be transmitted in a wireless manner, so as to respectively activate the first graphic user interface and the second graphic user interface to be displayed on the display apparatus 30 for the users to view and select.

In the present embodiment, it is preferred that the first user operating apparatus 361 and the second user operating apparatus 362 respectively are used for two different users or family members, and meanwhile the users can self-organize and edit respective graphic user interfaces in advance according to the foregoing setting technology and then load the edited graphic interfaces into the set top box 31 for the follow-up use of watching video/audio programs. Besides using the foregoing setting technology to edit settings, i.e., using an editing software in the personal computer 35 to amend or edit settings in advance, a feature of the present invention is associated with using the first user operating apparatus 361 or the second user operating apparatus 362 directly to amend graphic user interface. More specifically, the editing software is also loaded into the set top box 31, the users can directly edit and amend graphic user interfaces for personal use by the respective user operating apparatus before using the corresponding user operating apparatus to run the individual-oriented graphic user interfaces. Using a display apparatus 30 to display a corresponding graphic user interface while activating the function of editing software is also a preferred implementation, thereby using relevant function keys on the user operating apparatus to perform self-organization and edit settings, and thereafter re-loading into the set top box 31 for update.

In the present embodiment, since different user operating apparatus 361, 362 match with the same set top box 31, instructions transmitted from the apparatus 361, 362 can be received and identified by the set top box 31. In particular, since the user operating apparatus 361, 362 are designed to be corresponding to different graphic user interfaces, and thus instructions can be designed to be with different codes. That is, a specific instruction is corresponding to a specific graphic user interface, so that when the first user operating apparatus 361 is operated, the first graphic user interface correspondingly is activated and displayed for editing settings or for starting to run; and when the second user operating apparatus 362 is operated, the second graphic user interface correspondingly is activated and displayed for editing settings or for starting to run.

The relevant function keys on the user operating apparatus include function keys such as arrow keys, number keys, a mode switching key and a confirm key and so on similar to that existing on a general remote controller. In the present embodiment, one implementation is to dispose on each of the user operating apparatus 361, 362 an additional user activation key, and the users with different identities can activate the corresponding graphic user interfaces to be displayed on the display apparatus 30 after they hand the corresponding user operating apparatus and press the user activation keys thereon. Or, another implementation is to re-define one of the existing function keys such as the power key to be the activation key for activating the corresponding graphic user interface, and when the activation key is pressed, since different operating apparatus would transmit instructions with different codes, the set top box 31 can identify which one graphic user interface ought to be activated.

Continuing the above-mentioned descriptions, just like the prior art, the set top box 31 can receive and process a digital video/audio signal for output, the display apparatus 30 can receive the processed video/audio signal and display corresponding channels and programs. Since the graphic user interfaces can be edited for setting in advance, activated and displayed different graphic user interfaces may have different contents. In the present invention, each of the graphic user interfaces may be a window interface constituted by multiple menus, and the menus are corresponding to respective video/audio channels and video/audio programs contained in the digital video/audio signal. Therefore, when operating different user operating apparatus 361, 362, the users may use the function keys such as arrow keys or the confirm key existing thereon to select desired options. In other words, the users can quickly select desired video/audio channels and video/audio programs to watch from the respective self-organized graphic user interfaces, and the display apparatus 30 may subsequently display the corresponding contents of the selected video/audio signal.

Furthermore, in order to meet different preferences and requirements of different users, the graphic user interfaces of the present invention can provide video/audio program lists set by different users through editing and setting in advance. The setting approaches of actually setting the video/audio program lists can be using the multi-media processing apparatus itself or an electronic apparatus (e.g., a personal computer) signal-connected to the multi-media processing apparatus to set the users' favorite video/audio program lists.

Of course, when the users use the multi-media processing apparatus or the electronic apparatus to set or access the video/audio program lists, the approach of such apparatus providing the video/audio program lists can be modified. For example, the video/audio programs undoubtedly can be displayed in a list mode, or instead are accessible by users in a folder (e.g., named my favorites) mode.

In the first embodiment, different user operating apparatus 361, 362 are used to activate the respective different graphic user interfaces. However, the members in a family might randomly use the user operating apparatus unmatched with their identities, and different graphic user interfaces might include relevant channels and programs under watching rank limitations or some classifications that are not suitable for the current user to watch. Therefore, in the present embodiment, during the user handholds the user operating apparatus and starts to operate, an identity confirm procedure is needed to be performed, and in the identity confirm procedure the function keys such as number keys, a confirm key on the user operating apparatus are used to perform the input of an preset password. When the identity confirm procedure is passed, that is, the input password matches with the member identity of the handheld user operating apparatus, the corresponding first graphic user interface or second graphic user interface would be activated and displayed, or otherwise, the corresponding graphic user interface would not be activated and displayed.

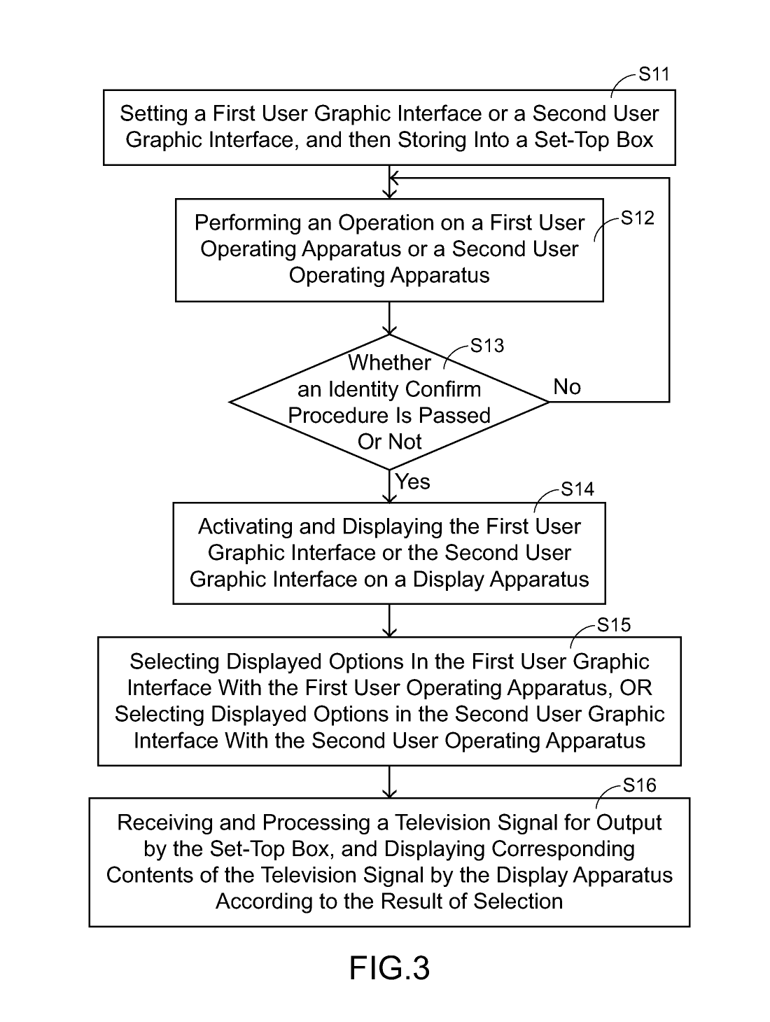

Referring to FIG. 3, an implementation flowchart according to the concept of the first embodiment is shown. Firstly, the first graphic user interface or the second graphic user interface is set in advance and then stored into the set top box 31 (step S11). Next, when the user wants to watch digital video/audio programs, perform an operation on the first user operating apparatus 361 or the second user operating apparatus 362 (step S12), in order to correspondingly activate the first graphic user interface or the second graphic user interface. During the process of the identity confirm procedure (step S13), if the identity confirm procedure is passed, the first graphic user interface or the second graphic user interface would be activated and displayed on the display apparatus 30 (step S14), whereas if the identity confirm procedure is not passed, repeatedly perform the foregoing steps. Subsequently, select displayed options in the first graphic user interface with the first user operating apparatus 361, or select displayed options in the second graphic user interface with the second user operating apparatus 362 (step S15). Finally, the set top box 31 receives and processes the video/audio signal for output, and the display apparatus 30 displays corresponding contents of the video/audio signal according to the result of selection (step S16).

In the first embodiment of the present invention, a corresponding number of user operating apparatus are employed to operate the respective graphic user interfaces stored in the set top box. Although the storage of the graphic user interface files in the digital set top box can vary with file sizes by increasing memory space so as to store multiple files, if the user's family have many members, the one-on-one design of user operating apparatus would increase the cost. Therefore, in a second embodiment of the present invention, it is proposed adapting one user operating apparatus to multiple graphic user interfaces in order to carry out a digital video/audio program watching process of the present invention.

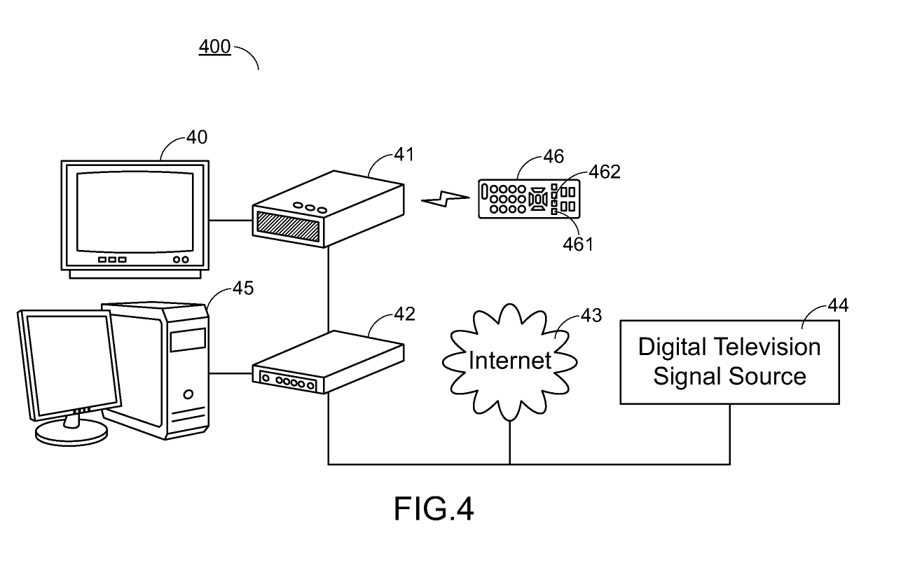

Referring to FIG. 4, a schematic view of a video/audio broadcasting system 400 in accordance with a second embodiment of the present invention is shown. The system architecture of the second embodiment is similar to that of the first embodiment, descriptions and illustration of hardware elements are also similar to those shown in FIG. 2 of the first embodiment, but the system in the present embodiment only includes one user operating apparatus 46. The multi-media processing apparatus in the present embodiment is a set top box 41 stored with two graphic user interfaces, i.e., a first graphic user interface and a second graphic user interface (not shown in the figure) self-organized and edited for setting in advance (the approach of setting can be the same as that in the first embodiment). Users with different identities can use the same user operating apparatus 46 to activate the respective graphic user interfaces and then make them be displayed on a display apparatus 40 for selection, so as to watch corresponding contents of the selected video/audio signal.

Continuing the above-mentioned descriptions, in the second embodiment, the user operating apparatus 46 can employ multiple user activation keys to provide an operation of an identity switching function, so that the users with different identities can correctly activate and find respective desired graphic user interfaces. When the single apparatus is given to another user for operation, a switchable activation among the graphic user interfaces can still be performed to provide a further selection process. Therefore, in the present embodiment, a preferred implementation is that the user operating apparatus 46 is designed to include a first user activation key 461 and a second user activation key 462, for providing the operation of the identity switching function. In other words, when one user presses the first user activation key 461, the first graphic user interface is correspondingly activated and displayed, and when another user presses the second user activation key 462, the second graphic user interface is correspondingly activated and displayed.

In a similar technology, since wireless signal instructions respectively caused by the first user activation key 461 and the second user activation key 462 are designed to be instructions with different codes, even if the users with different identities operate the same user operating apparatus 46, the first graphic user interface or second graphic user interface, which is desired, can still be correspondingly activated and displayed by the receiving and identifying of the set top box 41. In another aspect, since the present embodiment is characterized in that different users operate the same operating apparatus to run the respective different graphic interfaces, it is possible that the user operating the user operating apparatus 46 activates the graphic interface set for the other user for watching. Therefore, in consideration of the limitations in factors such as watching rank or unsuitable classification, the identity confirm procedure as described in the first embodiment can also be adopted in the present embodiment. Herein, the identity confirm procedure, the subsequent option selection and the corresponding displaying of video/audio channels and video/audio programs all are the same as those in the first embodiment, and thus are not to be repeated.

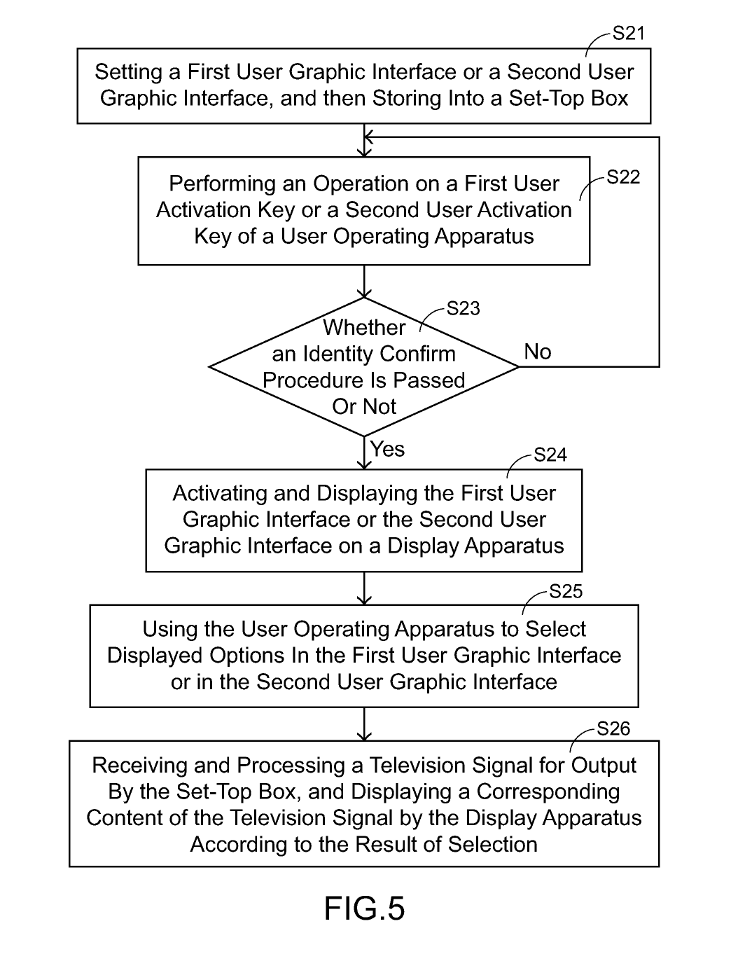

Referring to FIG. 5, an implementation flowchart according to the concept of the second embodiment is shown. Firstly, the first graphic user interface or the second graphic user interface is set in advance and then stored into the set top box 41 (step S21). Next, when a user wants to watch digital video/audio programs, perform an operation on the first user activation key 461 or the second user activation key 462 (step S22), in order to activate the first graphic user interface or the second graphic user interface. During the process of the identity confirm procedure (step S23), if the identity confirm procedure is passed, the first graphic user interface or the second graphic user interface is activated and displayed on the display apparatus 40 (step S24), whereas if the identity confirm procedure is not passed, repeatedly perform the foregoing steps. Subsequently, use the user operating apparatus 46 to select displayed options shown in the first graphic user interface or the second graphic user interface (step S25). Finally, the set top box 41 receives and processes the video/audio signal for output, and the display apparatus 40 displays corresponding contents of the video/audio signal according to the result of selection (step S26).

The present invention further provides a third embodiment, which likewise utilizes one user operating apparatus corresponding to multiple graphic user interfaces as the technology basis, and 3 further utilizes a program design to increase the multiplication of applied numbers.

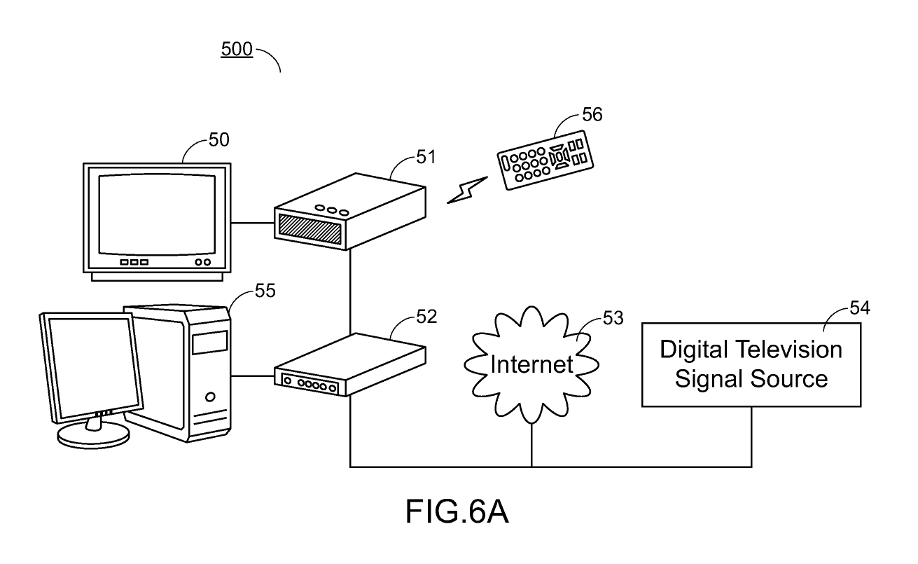

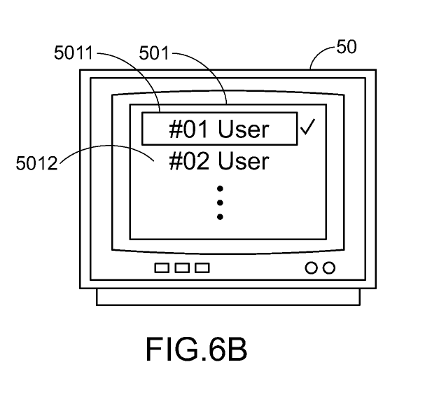

Referring to FIG. 6A, a schematic view of a video/audio broadcasting system 500 in accordance with the third embodiment of the present invention is shown. The system architecture of the third embodiment is similar to that of the second embodiment, but the user operating apparatus 56 in the present embodiment no longer has the need to design a corresponding number of multiple user activation keys. Instead, less or only one user activation key is designed to perform the identity switching operation; or a conventional remote controller is used as the user operating apparatus of the present invention with one of existing function keys such as power key, mode switching key and so on designated as the above-mentioned single user activation key.

The descriptions and expression of hardware elements in the present embodiment are similar to those in the second embodiment as illustrated in FIG. 4. The multi-media processing apparatus in the present embodiment is a set top box 51 stored with two graphic user interfaces, i.e., a first graphic user interface and a second graphic user interface self-organized and edited for setting in advance. When the above-mentioned single activation key or mode switching key is pressed, the present embodiment is designed to further display an identity switching interface on the display apparatus 50, for switchably activating corresponding graphic user interfaces.

Referring to FIG. 6B, a schematic view of an identity switching interface 501 proposed in the third embodiment of the present invention is shown. The identity switching interface 501 is firstly stored into the set top box 51, just like the previously set first and second graphic user interfaces. When the single activation key or mode switching key is pressed, the identity switching interface 501 is displayed on the display apparatus 50, wherein the displayed contents include a number of activation options respectively corresponding to the number of the stored graphic user interfaces.

As illustrated in the figure, the identity switching interface 501 includes a first user activation option 5011 and a second user activation option 5012. In a selection application, the first user activation option 5011 is for activating and displaying, and/or further editing the setting of the first graphic user interface as desired; and the second user activation option 5012 is for activating and displaying, and/or further editing the setting of the second graphic user interface as desired. For practicing the selection, the user operating apparatus 56 is used to perform the identity switching operation. The function keys such as arrow keys, number keys and confirm key may be used to select the first user activation option 5011 or the second user activation option 5012.

Accordingly, the first or second graphic user interface may be activated and displayed according to operational requirement, and may be modified or edited for setting by the user. In addition, the amount of the stored graphic user interfaces is no longer subjected to the design limitation of hardware key, but depends on size of the memory space so as to satisfy the operation requirements of the members. Regarding the identity confirm procedure, the option selection of graphic user interfaces, and the corresponding displaying of channels and programs, they are the same as those described in the foregoing two embodiments and thus will not be repeated herein.

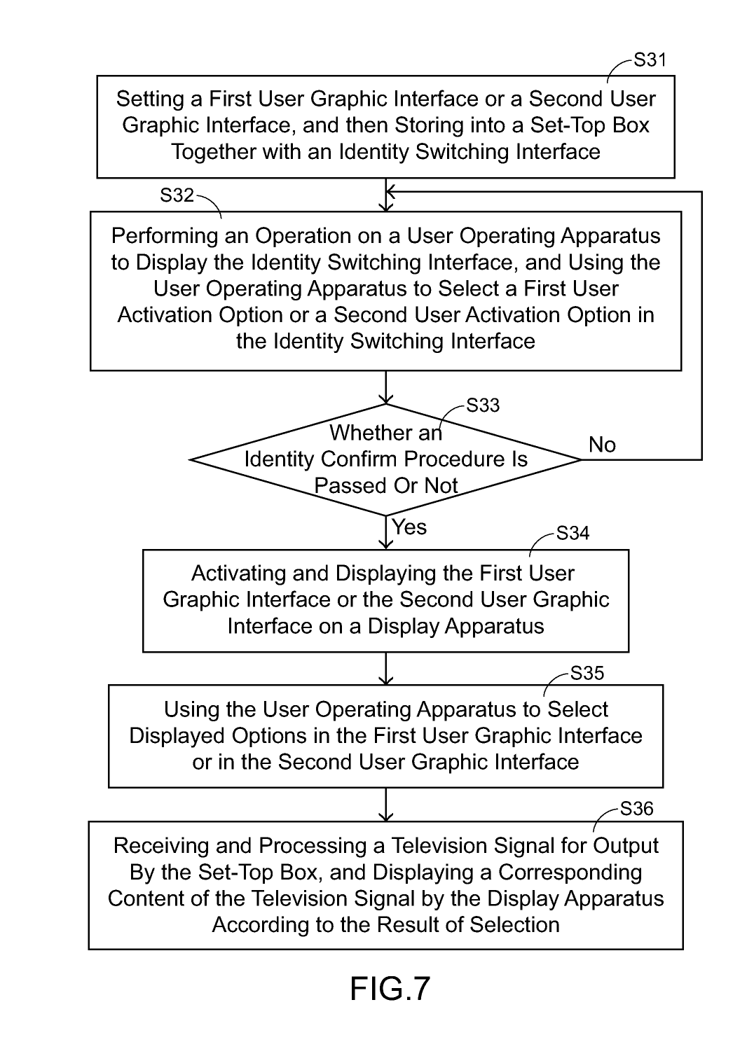

Referring to FIG. 7, a flowchart implementing the concept of a third embodiment is illustrated. Firstly, the first graphic user interface or the second graphic user interface is set in advance and then are stored into the set top box 51 together with the corresponding identity switching interface 501 (step S31). Next, when a user wants to watch digital video/audio programs, perform an operation on the user operating apparatus 56 to display the identity switching interface 501 and use the user operating apparatus 56 to select the first user activation option 5011 or the second user activation option 5012 in the identity switching interface (step S32), which is prepared for switching to and activating a corresponding one of the first graphic user interface and the second graphic user interface. During the identity confirm procedure (step S33), if the identity confirm procedure is passed, the first graphic user interface or the second graphic user interface would be activated and displayed on the display apparatus 50 (step S34), whereas if the identity confirm procedure is not passed, repeatedly perform the foregoing steps. Subsequently, use the user operating apparatus 56 to make selection from the displayed options in the first graphic user interface or the second graphic user interface (step S35). Finally, the set top box 51 receives and processes the video/audio signal for output, and the display apparatus 50 displays corresponding contents of the video/audio signal according to the result of selection (step S36).

In the above-described three embodiments aiming at the application of digital video/audio program broadcast at an user end, the digital set top box is taken as a typical example of the multi-media processing apparatus of the present invention, and the connection to and combination with traditional display apparatus are taken for illustration. However, for a digital TV set with the technology of set top box or multi-media processing apparatus incorporated in a display apparatus, the inventive concept of the present invention can also be implemented on such digital TV set. That is, functions of the multi-media processing apparatus and the display apparatus of the video/audio broadcasting system of the present invention are combined, and a digital TV set or a digital multi-media apparatus having digital processing and broadcasting functions is a typical example of integration. The graphic user interfaces or the identity switching interface and so on can be stored in an associated memory unit of the digital TV set or the digital multi-media apparatus having digital processing and broadcasting functions after being edited or set.

Furthermore, in the above-described various embodiments remote controller(s) with entity keys are used as the user operating apparatus to make selection from the displayed options so as to have video/audio programs broadcasted. As far as feasible means are concerned, the user operation apparatus of the present invention can be replaced by other hardware apparatus, for example a touch screen, a touch panel, a personal digital assistant (PDA) or a mobile electronic apparatus, etc., which exhibits a remote operation function and an interface display function. When such type of apparatus is adopted to perform an operation, what the user needs to do is only to make selection from the contents displayed on an auxiliary screen, and the operation concept of multiple graphic user interfaces according to the present invention can also be practiced. In another aspect, when such type of apparatus, for example, the touch screen, the touch panel, the PDA or the mobile electronic apparatus, is adopted to perform an operation, the self-organization and editing functions of the graphic user interfaces according to the present invention can also be performed in such apparatus.

In another aspect, in the above-described various embodiments the use of two user operating apparatus or two graphic user interfaces is given as an example for illustration, but the inventive concept of the present invention is not limited to two but applicable with more than two user operating apparatus or graphic user interfaces. For example, in the first embodiment, the user's family can configure more than two user operating apparatus and corresponding graphic user interfaces at the prerequisite of having enough expense and enough memory space of the set top box; or in the second embodiment, in consideration of the surface area of the user operating apparatus, it is designed to use more than two corresponding user activation keys; or in the third embodiment, more than two graphic user interfaces are configured at the prerequisite of the set top box having enough memory space.

It is indicated that, even if the sources of video/audio signal accessible by the multi-media processing apparatus could be different, the present invention would not be limited thereby. That is, in spite of the foregoing preferred embodiments use the IPTV (MOD service provided by Telecommunication Company) as an example, in the practical applications, the provision of video/audio programs can be implemented in a manner that the video/audio provider or the user in use of a video/audio signal providing apparatus transfers video/audio program signals according to the need of application. If the source of the video/audio program signal to be watched by the user is provided from a network server through Internet, for example in the application of receiving the video/audio programs by a network-attached storage (NAS), the multi-media processing apparatus still can, according to the proposed solution of the present invention, provide corresponding graphic user interfaces based on the requirement of the users and subsequently hereby receive corresponding video/audio signals and programs.

In summary, the present invention adopts storing multiple graphic user interfaces into a set top box or a multi-media processing apparatus or an integrated digital TV set along with the employ of the user operating apparatus through which editing and setting can be performed and identity switching can be correspondingly activated and used, and thus facilitates each of the members to self-organize individual-oriented selection interface for desired channel programs in the application of watching digital video/audio programs for a family with multiple members; and furthermore the control of identity confirmation with respect to the activation of a different member's interface by a user can be executed. Accordingly, the present invention can effectively solve the related issues existing in the prior art, and thus can successfully achieve the primary object that the present invention is developed for.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. (canceled)

2. (canceled)

3. A video/audio broadcasting method performed in a video/audio broadcasting system, comprising:
selectively activating a specified one of a plurality of graphic user interfaces according to an operation of a user on the video/audio broadcasting system; and
receiving and broadcasting contents of a video/audio signal according to an operation of a user on the specified graphic user interface.

4. The video/audio broadcasting method according to claim 3, further comprising:
diversely editing an original interface to obtain respective settings of the plurality of graphic user interfaces; and
storing the settings of the plurality of graphic user interfaces into the video/audio broadcasting system.

5. The video/audio broadcasting method according to claim 3, wherein the operation of the user for activating the specified graphic user interface is an operation on a functional key which is disposed in a user operating apparatus or one of a plurality of user operating apparatus included in the video/audio broadcasting system.

6. The video/audio broadcasting method according to claim 5, further comprising:
performing an identity switching function to activate another graphic user interface instead of the specified graphic user interface when another functional key disposed in the same user operating apparatus or another one of the plurality of user operating apparatus included in the video/audio broadcasting system is operated.

7. The video/audio broadcasting method according to claim 6, further comprising:
performing an identity confirm procedure to determine whether the specified graphic user interface or the another graphic user interface can be activated.

8. The video/audio broadcasting method according to claim 5, further comprising:
displaying an identity switching interface including a plurality of user activation options corresponding to the plurality of graphic user interfaces, respectively, whereby the specified graphic user interface is activated by triggering a corresponding one of the user activation options with the functional key.

9. The video/audio broadcasting method according to claim 5, wherein the multi-media processing apparatus is a digital TV or a set top box, and video/audio programs included in the specified graphic user interface are displayed on a displaying apparatus in a list mode or a folder mode.

10. A video/audio broadcasting system, comprising:
at least one user operating apparatus, one of which is selectively operated by a user for activating a specified one of a plurality of graphic user interfaces; and
a multi-media processing apparatus in communication with the at least one user operating apparatus and a video/audio signal source for receiving and broadcasting contents of a video/audio signal from the video/audio signal source according to an operation of a user on the specified graphic user interface.

11. The video/audio broadcasting system according to claim 10, wherein the at least one user operating apparatus includes a single user operating apparatus simultaneously corresponding to the plurality of graphic user interfaces or a plurality of user operating apparatus respectively corresponding to the plurality of graphic user interfaces.

12. The video/audio broadcasting system according to claim 10, further comprising:
an electronic apparatus in communication with the multi-media processing apparatus, provided for a user to diversely edit an original interface into the plurality of graphic user interfaces, and store the plurality of graphic user interfaces into the multi-media processing apparatus; and
a displayed apparatus in communication with the multi-media processing apparatus, provided for displaying the specified graphic user interface, which is activated in response to an operation on a functional key disposed in one of the at least one user operating apparatus, or an operation on an identity switching interface previously displayed on the displayed apparatus in response to an operation on a functional key disposed in one of the at least one user operating apparatus.

13. The video/audio broadcasting system according to claim 10 wherein the electronic apparatus stores the plurality of graphic user interfaces into the multi-media processing apparatus via Internet.

14. The video/audio broadcasting system according to claim 10 wherein the at least one user operating apparatus are in communication with the multi-media processing apparatus via wireless signals.

15. The video/audio broadcasting system according to claim 10 wherein the at least one user operating apparatus includes a plurality of user operating apparatus, each of which includes a functional key for activating a corresponding one of the plurality of graphic user interfaces.

16. (canceled)

17. The video/audio broadcasting system according to claim 10 wherein the at least one user operating apparatus includes a single user operating apparatus, which includes a functional key optionally triggered to activate an identity switching interface including a plurality of user activation options, one of which is operable to activate the specified graphic user interface.

18. The video/audio broadcasting system according to claim 10 wherein the video/audio signal source is transferred via a video/audio provider or a user in use of a video/audio signal providing apparatus.
